(19) United States
(12) Patent Application Publication
(10) Pub. No.: US 2026/0091761 A1
(43) Pub. Date: Apr. 2, 2026

(54) ADAPTER ASSEMBLY FOR A VEHICLE WIPER SYSTEM

(71) Applicant: VALEO SYSTEMES D'ESSUYAGE, La Verriere (FR)

(72) Inventors: Thomas CAETANO, La Verriere (FR); Stephane HOUSSAT, La Verrière (FR); Vincent GAUCHER, La Verrière (FR)

(73) Assignee: VALEO SYSTEMES D'ESSUYAGE, La Verriere (FR)

(21) Appl. No.: 18/904,142

(22) Filed: Oct. 2, 2024

(51) Int. Cl. B60S 1/40

(52) U.S. Cl. CPC B60S 1/4003; B60S 1/4048

(57) ABSTRACT

The present invention relates to an adapter assembly for a vehicle wiper system. The adapter assembly includes a base member pivotally mounted on a connector of a wiper blade, a platform member connected to a rear end of the base member, and a locking cap pivotally connected to a front end of the base member. The base member includes a guiding tab formed near front end to guide and support a front end of a wiper arm. The base member further includes a seating tab to support side walls of the wiper arm. The platform member includes an inverted L-shaped locking feature formed on outer surfaces of side walls of the platform member, to restrict vertically upward and longitudinally rearward movement of the wiper arm with respect to the adapter assembly. The locking cap may be locked on the base member by a securing means.

### TECHNICAL FIELD

The present invention relates to a windscreen wiper system for a motor vehicle, and more particularly to an adapter assembly for connecting a windscreen wiper blade to an arm of a wiper system.

### BACKGROUND OF THE INVENTION

The wiper system traditionally consists of a wiper arm, one end of which is connected to an output shaft of a wiper motor through linkages and a wiper blade is attached to another end of the wiper arm. The wiper motor drives the wiper arm to swing between the predefined angular positions to wipe out the water and dirt present on the windshield.

Each wiper blade comprises a structure supporting a wiper rubber intended to be placed in contact with the windscreen so that it can remove water and/or dirt from the windscreen panel. Additionally, each wiper blade comprises a connector rigidly connected to the structure of the wiper blade and an adapter assembly mounted pivotally on the connector in order to allow the detachable fastening of the wiper arm of the wiper system to the adapter assembly.

In a known manner, a yoke/clevis is formed at the end of the wiper arm and the yoke/clevis is engaged with the adapter assembly and locked therein. There are variety of wiper arms having different designs of the yoke, being used in different motor vehicles. This requires motor vehicle manufacturers to design adapter assembly specific to each type of wiper arm, an adapter assembly specifically making the link between a type of wiper arm and a connector. So, the equipment manufacturers need to develop many different adapters, including at least one for each type of wiper arm on the market. Further, the users who need to change their wiper blade, needs to adapt and take extra care to choose the right adapter assembly for the type of wiper arm on which the wiper blade is to be mounted. This creates lot of inconvenience to the user while changing the wiper blades.

### SUMMARY OF THE INVENTION

An object of the present invention is to solve the disadvantages described above of known adapter assembly. In particular, an object of the present invention is to provide an adapter assembly compatible with multiple wiper arms.

Another object of the present invention is to provide an adapter assembly compatible with wiper arm having inverted U-shaped yoke with pins provided on inner surface of side walls of the yoke.

Yet another object of the present invention is to provide an adapter assembly including a base member, a platform member, and a locking cap, adapted for securely connecting the wiper arm to the wiper blade.

In this context, the present invention is directed towards an adapter assembly for a wiper system. The adapter assembly may include a base member, a platform member, and a locking cap. The base member may have a front end and a rear end. The platform member may have two side walls extending between a front end of the platform member and a rear end of the platform member. At least the rear end of the platform member may be connected to the rear end of the base member. Preferably, the rear end of the platform member may be pivotally connected to the rear end of the base member. Alternatively, the rear end of the platform member may be fixedly connected to the rear end of the base member. Further, preferably, the front end of the platform member may be releasably secured to the front end of the base member. Alternatively, the front end of the platform member may be fixedly secured to the front end of the base member. The locking cap may have a lower end, the lower end of the locking cap being pivotally connected to the front end of the base member. The platform member may include a locking feature formed on at least one of the side walls. The locking feature may be adapted to restrict at least longitudinally rearward and vertically upward movement of a wiper arm with respect to the platform member. Preferably, the locking feature may be formed on both the side walls of the platform member, to cooperate with the wiper arm.

In a non-limiting embodiment of the present invention, the base member may include longitudinal walls spaced apart from each other. The longitudinal walls may extend between the rear end of the base member and the front end of the base member. The base member may be adapted to be pivotally connected to a connector of a wiper blade. The base member may be positioned towards upper side of the connector, and lower side of the connector may be fixed to a structure of the wiper blade.

In a non-limiting embodiment of the present invention, the base member may further include a guiding tab formed on outer surface of at least one of the longitudinal walls. The guiding tab may be positioned near the front end of the base member. Preferably, the guiding tab may be formed on outer surfaces of both the longitudinal walls of the base member. The guiding tab(s) may be adapted to guide a front end of a yoke of the wiper arm, while mounting the wiper arm on the adapter assembly. The guiding tab(s) may further be adapted to restrict longitudinally forward and vertically downward movement of the yoke with respect to the base member.

In a non-limiting embodiment of the present invention, the guiding tab may include a guiding profile having curved shape and a seating profile having a longitudinal portion and/or an inclined portion. The curved shape of the guide profile is adapted to guide the front end of the yoke such that the yoke of the wiper arm cooperates with the locking feature of the platform member for restricting longitudinally rearward and vertically upward movement of the wiper arm with respect to the adapter assembly.

In a non-limiting embodiment of the present invention, the base member may further include a seating tab formed on outer surface of at least one of the longitudinal walls. The seating tab may have a top surface adapted to cooperate with the wiper arm. Preferably, the seating tab may be formed on outer surfaces of both the longitudinal walls of the base member. Moreover, the seating tab may cooperate with the yoke of the wiper arm to restrict vertically downward movement of the wiper arm with respect to the base member of the adapter assembly.

In a non-limiting embodiment of the present invention, the base member may further include a flexible tab provided on at least one of the longitudinal walls. The flexible tab may be formed near the front end of the base member. Preferably, the flexible tab may be provided on both the longitudinal walls of the base member. Moreover, the flexible tab may be provided in the form of cantilever leg inclined outwards in its neutral state, and deformable inwards. The flexible tab may be adapted to cooperate with the yoke and may be deformed to grip the yoke from inner side of the side walls of the yoke.

In a non-limiting embodiment of the present invention, the locking feature may include a horizontal rib extending longitudinally on the side wall of the platform member, and a vertical rib extending downwards from rear end of the horizontal rib. The horizontal rib along with the vertical rib may form a continuous rib having inverted L-shape. Therefore, the horizontal rib may cooperate with the yoke of the wiper arm to restrict vertically upward movement of the wiper arm with respect to the platform member, and the vertical rib may cooperate with the yoke of the wiper arm to restrict longitudinally rearward movement of the wiper arm with respect to the platform member.

In a non-limiting embodiment of the present invention, the locking cap may include a fastening means. The fastening means may be adapted to cooperate with corresponding openings provided on the base member. The locking cap may pivoted from an unlocked state to a locked state. In locked state, the locking cap may be secured to the base member by the fastening means. Preferably, the fastening means may include deformable lugs formed on the locking cap, the deformable lugs may be adapted to be received in corresponding openings formed on the longitudinal walls of the base member, to secure the locking cap to the base member.

In a non-limiting embodiment of the present invention, the locking cap may include a lip portion formed at an end opposite to the lower end. The lip portion may include a step adapted to cooperate with the wiper arm. The step formed on the lip portion of the locking cap may cooperate with the front end of the yoke of the wiper arm, when the locking cap pivoted and secured to the base member in locked state. The lip portion is adapted to restrict upwards movement of the front end of the yoke with respect to the adapter assembly.

The present invention also relates to a wiper system for a motor vehicle. The wiper system may include a connector, a base member, a platform member, a locking cap, and a wiper arm. The connector may be adapted to be attached to a wiper blade. The wiper blade may include a wiper rubber attached to a structure, and the connector may be attached to the structure. The base member may have a front end and a rear end. The base member may be pivotally connected to the connector. The base member may be positioned towards upper side of the connector, and lower side of the connector may be fixed to the structure of the wiper blade. The platform member may have a front end and a rear end. At least the rear end of the platform member may be connected to the rear end of the base member. Preferably, the rear end of the platform member may be pivotally connected to the rear end of the base member. Alternatively, the rear end of the platform member may be fixedly connected to the rear end of the base member. Further, preferably, the front end of the platform member may be releasably secured to the front end of the base member. Alternatively, the front end of the platform member may be fixedly secured to the front end of the base member. The locking cap may have a lower end. The lower end of the locking cap may be pivotally connected to the front end of the base member. The wiper arm may be adapted to be releasably secured to the platform member and to the base member. The base member, platform member, and the locking cap may define an adapter assembly. The platform member may include two side walls extending between the front end and the rear end of the platform member. The platform member may further include a locking feature formed on at least one of the side walls. The locking feature may be adapted to restrict at least longitudinally rearward and vertically upward movement of the wiper arm with respect to the platform member. Preferably, the locking feature may be formed on both the side walls of the platform member, to cooperate with the wiper arm.

In a non-limiting embodiment of the present invention, the wiper arm may include a yoke having two side walls spaced apart from each other and connected to each other by an upper wall, and a pin formed on inner surface of at least one of the side walls of the yoke. The side walls and the upper wall of the yoke may define inverted U-shaped yoke, and the pin may be formed on inner surfaces of both the side walls. The pins may be provided at such a location on the side wall that the pin cooperates with the locking feature of the platform member, when the wiper arm is connected to the adapter assembly. The yoke may have a front end formed at free end of the wiper arm.

In a non-limiting embodiment of the present invention, the base member may include longitudinal walls spaced apart from each other. The longitudinal walls may extend between the rear end of the base member and the front end of the base member.

In a non-limiting embodiment of the present invention, the base member may include a guiding tab formed on outer surface of at least one of the longitudinal walls. The guiding tab may be positioned near the front end of the base member. Preferably, the guiding tab may be formed on outer surfaces of both the longitudinal walls of the base member. The guiding tab(s) may be adapted to guide the front end of a yoke of the wiper arm, while mounting the wiper arm on the adapter assembly. The guiding tab(s) ensures that the pins of the yoke are properly secured in the locking feature of the platform member, while mounting the wiper arm on the adapter assembly. The guiding tab(s) may further be adapted to restrict longitudinally forward and vertically downward movement of the yoke with respect to the base member.

In a non-limiting embodiment of the present invention, the guiding tab may include a guiding profile having curved shape, and a seating profile having a longitudinal portion and/or an inclined portion. The curved shape of the guide profile is adapted to guide the front end of the yoke such that the pins of the yoke cooperates with the locking feature of the platform member for restricting longitudinally rearward and vertically upward movement of the wiper arm with respect to the adapter assembly. Further, the longitudinal portion of the seating profile may restrict vertically downward movement of the yoke with respect to the base member. Moreover, the inclined portion of the seating profile may restrict longitudinally forward movement of the yoke with respect to the base member.

In a non-limiting embodiment of the present invention, the base member may further include a seating tab formed on outer surface of at least one of the longitudinal walls. The seating tab may have a top surface adapted to cooperate with the wiper arm. Preferably, the seating tab may be formed on outer surfaces of both the longitudinal walls of the base member. Moreover, the top surface of the seating tab may cooperate with the side walls of the yoke to restrict vertically downward movement of the wiper arm with respect to the base member of the adapter assembly.

In a non-limiting embodiment of the present invention, the base member may further include a flexible tab provided on at least one of the longitudinal walls. The flexible tab may be formed near the front end of the base member. Preferably, the flexible tab may be provided on both the longitudinal walls of the base member. Moreover, the flexible tab may be provided in the form of cantilever leg adapted to deform to grip the yoke from inner side of the side walls of the yoke.

In a non-limiting embodiment of the present invention, the locking feature may include a horizontal rib extending longitudinally on the side wall, and a vertical rib extending downwards from rear end of the horizontal rib. The horizontal rib along with the vertical rib may form a continuous rib having inverted L-shape. Therefore, the horizontal rib may cooperate with the pin of the yoke to restrict vertically upward movement of the yoke with respect to the platform member, and the vertical rib may cooperate with the pin of the yoke to restrict longitudinally rearward movement of the yoke with respect to the platform member.

In a non-limiting embodiment of the present invention, the locking cap may include a fastening means. The fastening means may be adapted to cooperate with corresponding openings provided on the base member. The locking cap may pivoted from an unlocked state to a locked state. In locked state, the locking cap may be secured to the base member by the fastening means. Preferably, the fastening means may include deformable lugs formed on the locking cap, the deformable lugs may be adapted to be received in corresponding openings formed on the longitudinal walls of the base member, to secure the locking cap to the base member.

In a non-limiting embodiment of the present invention, the locking cap may include a lip portion formed at an end opposite to the lower end. The lip portion may include a step adapted to cooperate with the wiper arm. The step formed on the lip portion of the locking cap may cooperate with the front end of the yoke of the wiper arm, when the locking cap pivoted and secured to the base member in locked state. The lip portion is adapted to restrict upwards movement of the front end of the yoke with respect to the adapter assembly.

### BRIEF DESCRIPTION OF DRAWINGS

The present invention is expounded in detail below with the aid of the presented drawings. Items shown in the drawings are not to scale and are simplified to increase clarity of disclosure. In the drawings:

FIG. 1A illustrates a schematic perspective view of a connection of a wiper arm with a connector of wiper blade, through an adapter assembly, according to an embodiment of present invention;

FIG. 1B illustrates an exploded view of the connection of FIG. 1A, according to an embodiment of present invention;

FIG. 2 illustrates an exploded view of the adapter assembly, according to an alternate embodiment of present invention;

FIG. 3A illustrates a schematic perspective view of the base member, according to an embodiment of present invention;

FIG. 3B illustrates a schematic side view of the base member, according to an embodiment of present invention;

FIG. 3C illustrates a zoomed view of the zone ‘Z1’ of FIG. 3A, according to an embodiment of present invention;

FIG. 3D illustrates a zoomed view of the zone ‘Z2’ of FIG. 3A, according to an embodiment of present invention;

FIG. 4A illustrates a schematic perspective view of the platform member, according to an embodiment of present invention;

FIG. 4B illustrates a zoomed view of the zone ‘Z3’ of FIG. 4A, according to an embodiment of present invention;

FIG. 5 illustrates a schematic perspective view of the platform member mounted on the base member, according to an embodiment of present invention;

FIG. 6A illustrates a schematic perspective view of a locking cap, according to an embodiment of present invention;

FIG. 6B illustrates a schematic side view of the locking cap, according to an embodiment of present invention;

FIG. 6C illustrates a schematic perspective view from rear side of the locking cap, according to an embodiment of present invention;

FIG. 6D illustrates a schematic rear view of the locking cap, according to an embodiment of present invention;

FIGS. 7A and 7B illustrate schematic perspective views of the adapter assembly, according to an embodiment of present invention;

FIG. 8A illustrates a schematic perspective view of a wiper arm, according to an embodiment of present invention;

FIG. 8B illustrates a schematic front view of the wiper arm, according to an embodiment of present invention;

FIGS. 9, 10, 11 and 12 illustrate the assembly steps for connecting the wiper arm to the adapter assembly, according to an embodiment of present invention;

FIG. 10A illustrates zoomed view of the zone ‘Z4’ of FIG. 10, according to an embodiment of present invention;

FIG. 10B illustrates zoomed view of the zone ‘Z5’ of FIG. 10, according to an embodiment of present invention; and

FIG. 10A illustrates a sectional view taken along line A-A in FIG. 11, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

Items shown in the drawings are not to scale and are simplified to increase clarity of disclosure.

The following embodiments are examples. Although the description refers to one or more embodiments, this does not necessarily mean that each reference is to the same embodiment, or that the features apply only to one embodiment. Simple features of different embodiments may also be combined and/or interchanged to provide further embodiments.

In the present description, certain elements or parameters may be indexed, for example first element or second element as well as first parameter and second parameter or first criterion and second criterion, etc. In this case, it is a simple indexing operation to differentiate and name elements or parameters or criteria which are close, but not identical. In this case, simple indexing is used to differentiate and name elements or parameters or criteria which are close, but not identical. This indexing does not imply that one element, parameter or criterion has priority over another, and such names can easily be interchanged without going beyond the scope of this description. Nor does this indexing imply an order in time, for example to assess a particular criterion.

In the following detailed description, the terms ‘longitudinal’, ‘transverse’ and ‘vertical’ refer to the orientation of a wiper system according to the invention. A longitudinal direction corresponds to a main direction of elongation of a wiper blade of this wiper system, this longitudinal direction being parallel to a longitudinal axis L of a reference frame L, V, T illustrated in the figures. A vertical direction corresponds to a stacking direction of a connector, an adapter assembly and a wiper arm of the wiper system, this vertical direction being parallel to a vertical axis V of the reference frame L, V, T and this vertical axis V being perpendicular to the longitudinal axis L. Finally, a transverse direction corresponds to a direction parallel to a transverse axis T of the reference frame L, V, T, this transverse axis T being perpendicular to the longitudinal axis L and the vertical axis V being perpendicular to the longitudinal axis L.

In addition, the designations ‘lower’ and ‘upper’ with respect to the elements of the wiper system are understood with respect to the distance of these elements from the wiper blade, a lower end/side of such elements corresponding to the end/side disposed in the vicinity of this wiper blade, while an upper end/side corresponds to the end/side disposed at a distance from the wiper blade. The designations ‘front’, ‘forward’, ‘rear’ and ‘rearward’ needs to be understood with reference to the longitudinal direction. Further, the designations ‘upward’ and ‘downward’ needs to be understood with reference to the vertical direction. The designation ‘length’ refers to the dimension of the component/element measured along the longitudinal direction L. Moreover, the designations ‘inner’ and ‘outer’ are understood with respect to the longitudinal central axis of the component. For example, the surface disposed towards the longitudinal central axis of the component may be referred as “inner surface” and the surface disposed away from the longitudinal central axis of the component may be referred as “outer surface”.

The present invention relates to a wiper system used to clean a glazed surface of a vehicle, for example a windscreen, so as to improve driver's visibility of the road in front of the vehicle. The wiper system generally comprises at least one wiper arm carrying at one end, a wiper blade which extends mainly along the longitudinal axis L. The wiper blade comprises at least one wiper strip (rubber), intended to be in contact with the glazed surface to be cleaned, and a support for the said wiper strip. The wiper blade is secured to the wiper arm by an adapter assembly. The adapter assembly according to the present invention includes a base member pivotally connected to a connecter of the wiper blade, a platform member connected to the base member at least at the rear end, and a locking cap pivotally connected to a front end of the base member. A locking feature may be formed on side walls of the platform member to cooperate with a pin provided on inner surface of the wiper arms, to restrict longitudinally rearward and vertically upward movement of the wiper arm with respect to the adapter assembly. The locking feature may be formed as a horizontal rib extending longitudinally and a vertical rib extending downwards from rear end of the horizontal rib. Further, the base member may include a guiding tab formed on longitudinal walls, near front end of the base member. The guiding tab may be adapted to guide a yoke of the wiper arm such that the pins of the wiper arm are received in the space formed by the horizontal and vertical ribs, during mounting of the wiper arm on the adapter assembly. The guiding tab may be further adapted to restrict longitudinally forward and vertically downward movement of the yoke of the wiper arm with respect to the adapter assembly. The base member may further include a seating tab having a top surface to cooperate with the side walls of the yoke, to restrict downward movement of rear portion of the yoke with respect to the adapter assembly. The base member may further include flexible tabs to grip the yoke for improving the connection of wiper arm with the adapter assembly. The locking cap may be pivoted and locked on the base member for further securing the yoke of the wiper arm on the adapter assembly. Therefore, the adapter assembly of present invention facilitates secure connection of the wiper arm having inverted U-shaped design with pins, to the connector of the wiper arm.

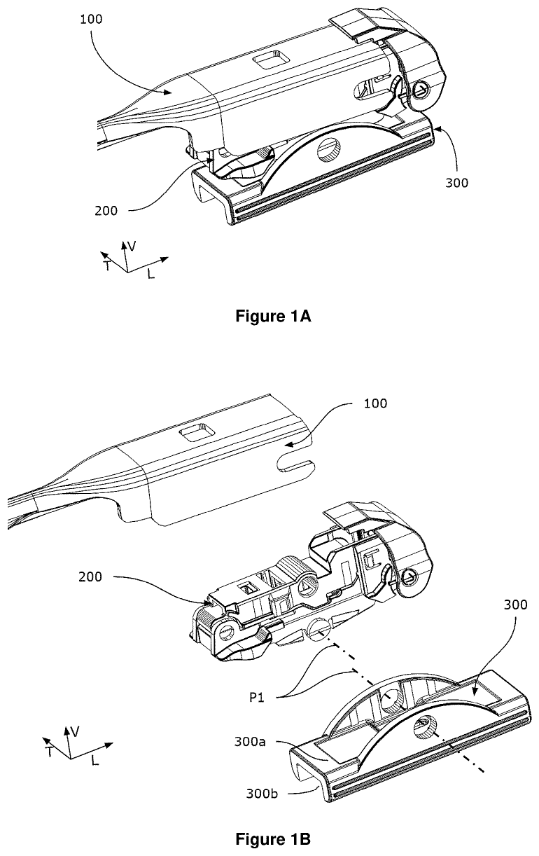

FIG. 1A illustrates a wiper system including a wiper arm 100 connected to a connector 300 of a wiper blade (not shown) through an adapter assembly 200. The connector 300 may be fixedly connected to a structure of the wiper blade. FIG. 1B illustrates an exploded view of the wiper system of FIG. 1A. As shown in FIG. 1B, the connector 300 may include an upper side 300a and a lower side 300b opposite to the upper side 300a. In particular, the lower side 300b may be designed to carry the structure of the wiper blade. The adapter assembly 200 may be located on the upper side 300a of the connector 300. The adapter assembly 200 may be pivotally connected to the connector 300 about a first pivot axis P1, thereby allowing the wiper blade to pivot at one of the ends of the wiper arm 100 to ensure that the wiper blade is pressed against the glass surface to be wiped.

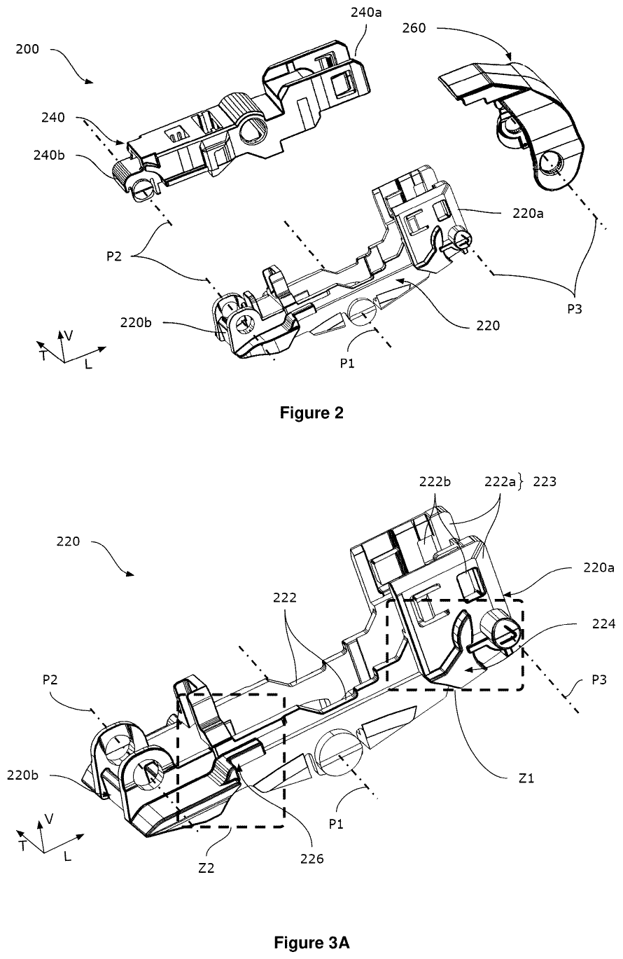

FIG. 2 shows exploded view of the adapter assembly 200. As shown, the adapter assembly 200 may include a base member 220, a platform member 240, and a locking cap 260. The base member 220 of the adapter assembly 200 may be pivotally mounted on the connector 300, about the first pivot axis P1. The base member 220 may extend along the longitudinal axis L, and may include a front end 220a and a rear end 220b, arranged on either sides of the first pivot axis P1. The adapter assembly 200 may further include the platform member 240 placed on upper side of the base member 220. The platform member 240 may extend along the longitudinal axis L, and may include a front end 240a and a rear end 240b. The rear end 240b of the platform member 240 may be connected to the rear end 220b of the base member 220. Preferably, the rear end 240b of the platform member 240 may be pivotally connected to the rear end 220b of the base member 220, about a second pivot axis P2. The locking cap 260 may be disposed in front of the base member 220. The locking cap 260 may be pivotally mounted about a third pivot axis P3 with the base member 220. This third pivot axis P3 may be disposed on the front end 220a of the base member 220.

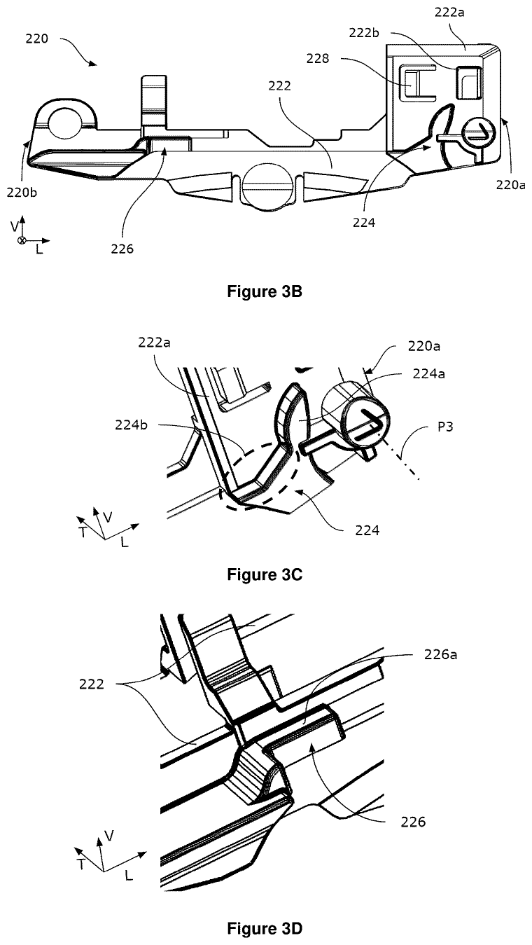

FIGS. 3A and 3B show the base member 220 including longitudinal walls 222 spaced apart from each other and extending between the rear end 220b and the front end 220a of the base member 220. A guide block 223 may be formed at the front end 220a of the base member 220 and the guide block 223 may be intended to receive the front end 240a of the platform member 240. The guide block 223 may include two side panels 222a integrally formed with the longitudinal walls 222 and extending parallel to each other. In particular, these side panels 222a help to define a recess near the front end 220a of the base member 220. In particular, the guide block 223 includes at least one recess (not shown) formed on an internal surface of one of the side panels 222a. Preferably, internal surfaces of each of the side panels 222a has a recess. At least one recess helps to form an indentation for receiving the front end 240a of the platform member 240. Further, an opening 222b may be formed in the side panels 222a of the guide block 223. Preferably, the openings 222b of the longitudinal walls 222 are aligned in transverse direction ‘T’. Further, the openings 222b may have a polygonal shape, for example, FIG. 3A shows rectangular openings 222b.

Further, a flexible tab 228 may be formed on at least one of the longitudinal walls 222. Preferably, the flexible tab 228 may be formed on the side panels 222a of the guide block 223. The flexible tab 228 may be provided in the form of a cantilever leg that may be deformable, when the wiper arm 100 is being mounted on the adapter assembly 200. The flexible tab 228 may be formed on both the longitudinal walls 222, and may be adapted to grip the wiper arm 100.

The base member 220 may further include a guiding tab 224 formed on at least one of the longitudinal walls 222, preferably on the outer surface of the side panel 222a of the guide block 223. The guiding tab 224 may be positioned between the first pivot axis P1 and the third pivot axis P3, near the third pivot axis P3. Preferably, the guiding tab 224 may be provided on both the longitudinal walls 222. The base member 220 may further include a seating tab 226 formed on at least one of the longitudinal walls 222, towards rear side of the first pivot axis P1. The seating tab 226 may extend outwards from the outer surface of the longitudinal wall 222. Preferably, the seating tab 226 may be provided on both the longitudinal walls 222.

FIG. 3C shows zoomed view of the guiding tab 224. As shown, the guiding tab 224 may be integrally formed with the longitudinal wall 222, and may extend outwards from the outer surface of the side panel 222a of the guide block 223. The guiding tab 224 may include a guiding profile 224a and a seating profile 224b. The guiding profile 224a may have a curved shape, as shown in FIG. 3C, which is adapted to guide the wiper arm 100 during attachment. The seating profile 224b may be formed in continuity with the guiding profile 224a, preferably towards rear side of the guiding profile 224a. The seating profile 224b may include longitudinally extending portion and/or upwardly inclined portion, which are adapted to cooperate with the wiper arm 100 to restrict longitudinally forward and vertically downward movement of the wiper arm 100, when the wiper arm 100 is secured to the adapter assembly 200.

FIG. 3D shows zoomed view of the seating tab 226. As shown, the seating tab 226 may protrude outwards from the longitudinal wall 222, and may extend longitudinally. The seating tab 226 may include a top surface 226a adapted to cooperate with the wiper arm 100 to restrict vertically downward movement of the wiper arm 100, when the wiper arm 100 is secured to the adapter assembly 200.

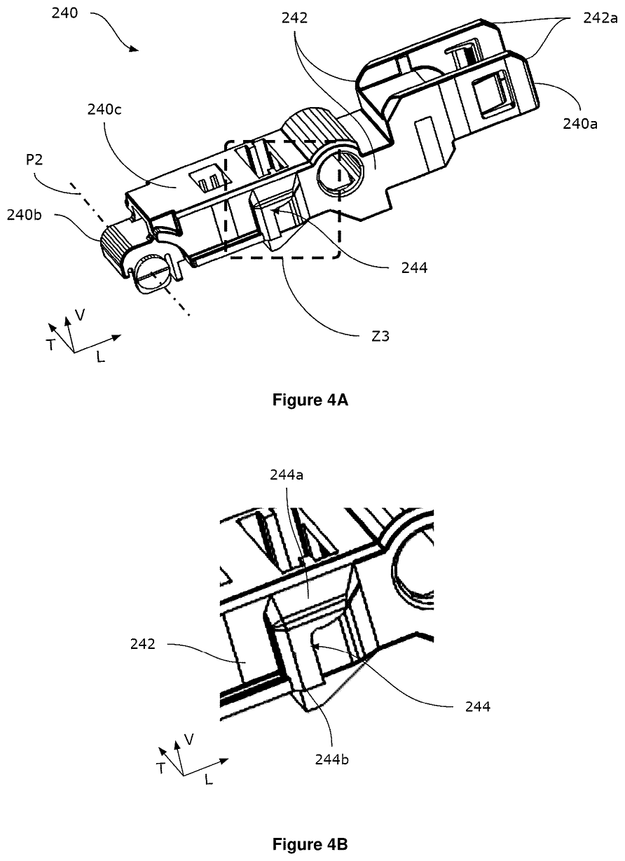

FIG. 4A shows the platform member 240 including side walls 242 extending between the rear end 240b and the front end 240a of the platform member 240. The side walls 242 may be spaced apart from each other, and may be connected to each other by an upper wall 240c. Preferably, the upper wall 240c may be integrally formed with the side walls 242, and the upper wall 240c may extend between upper edges of the side walls 242, as shown in FIG. 4A. The upper wall 240c may extend at least partially along the length of the side walls 242. The upper wall 240c may include multiple portions separated longitudinally from each other. Further, the upper wall 240c may include flat and/or curved portions, as per the design requirements.

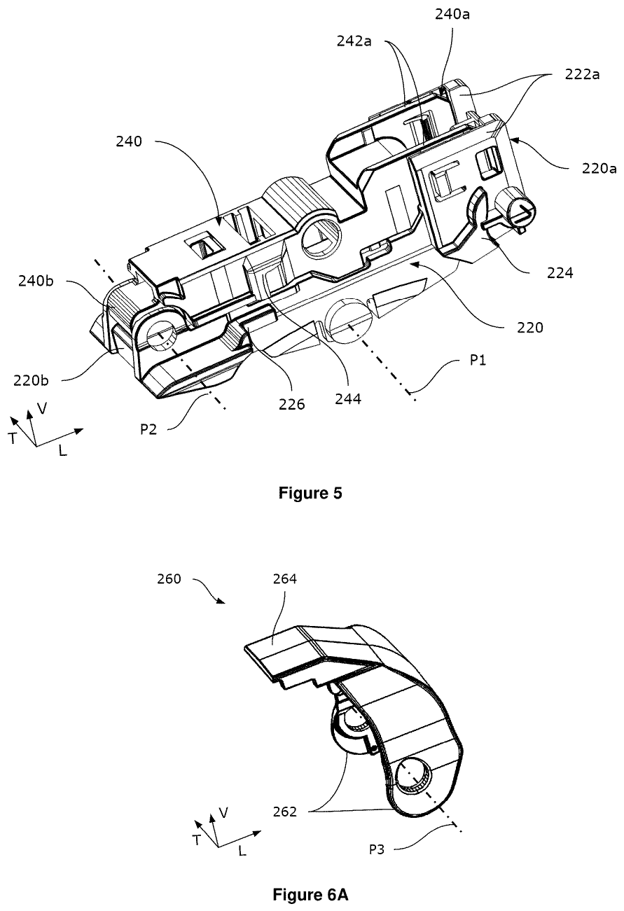

The front end 240a of the platform member 240 may include tongues 242a integrally formed with the side walls 242. These tongues 242a of the platform member 240 may be designed to be received in the guide block 223 of the base member 220, when the platform member 240 is in its folded position, as shown in FIG. 5.

As shown in FIG. 4A, a locking feature 244 may be formed on at least one of the side walls 242. Preferably, the locking feature 244 may be provided on both the side walls 242, more preferably the locking feature 244 may be formed on outer surfaces of the side walls 242. The locking feature 244 may be adapted to cooperate with the wiper arm 100 to restrict upward and rearward movement of the wiper arm 100 with respect to the adapter assembly 200.

FIG. 4B shows zoomed view of the locking feature 244. As shown, the locking feature 244 may include a horizontal rib 244a extending longitudinally on the side wall 242, and a vertical rib 244b extending downwards from rear end of the horizontal rib 244a. The horizontal rib 244a and the vertical rib 244b may together form inverted ‘L’ shaped protrusion on the side wall 242. When the wiper arm 100 is secured to the adapter assembly 200, the horizontal rib 244a may cooperate with a corresponding locking feature such as a pin provided on the wiper arm 100, to restrict upwards movement of the wiper arm 100 with respect to the platform member 240. Further, the vertical rib 244b may cooperate with the locking feature of the wiper arm 100, to restrict rearward movement of the wiper arm 100 with respect to the platform member 240.

FIG. 5 shows the platform member 240 mounted on the base member 220. The rear end 240b of the platform member 240 may be connected to the rear end 220b of the base member 220. Preferably, the rear end 240b of the platform member 240 may be pivotally connected to the rear end 220b of the base member 220, about the second pivot axis P2. Alternatively, the rear end 240b of the platform member 240 may be fixedly connected to the rear end 220b of the base member 220. The platform member 240 may be in the folded position, i.e. the platform member 240 is folded back against the upper side of the base member 420. The tongues 242a of the platform member 240 may be received in the recesses (not visible) formed on the side panels 222a of the guide block 223. It is to be noted that the guiding tab 224 and the seating tab 226 of the base member 220 may protrude outside from the outer surfaces of the longitudinal walls 222 of the base member 220, and may also be positioned outside of the side walls 242 of the platform member 240. Similarly, the locking feature 244 of the platform member 240 may protrude outside from the side walls 242 of the platform member 240, and may be positioned outside of the longitudinal walls 222 of the base member 220.

The first pivot axis P1 and the second pivot axis P2 may be offset vertically with respect to each other.

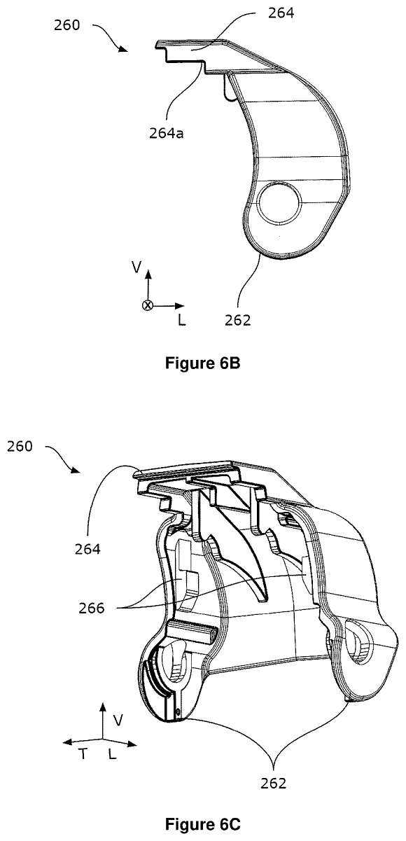

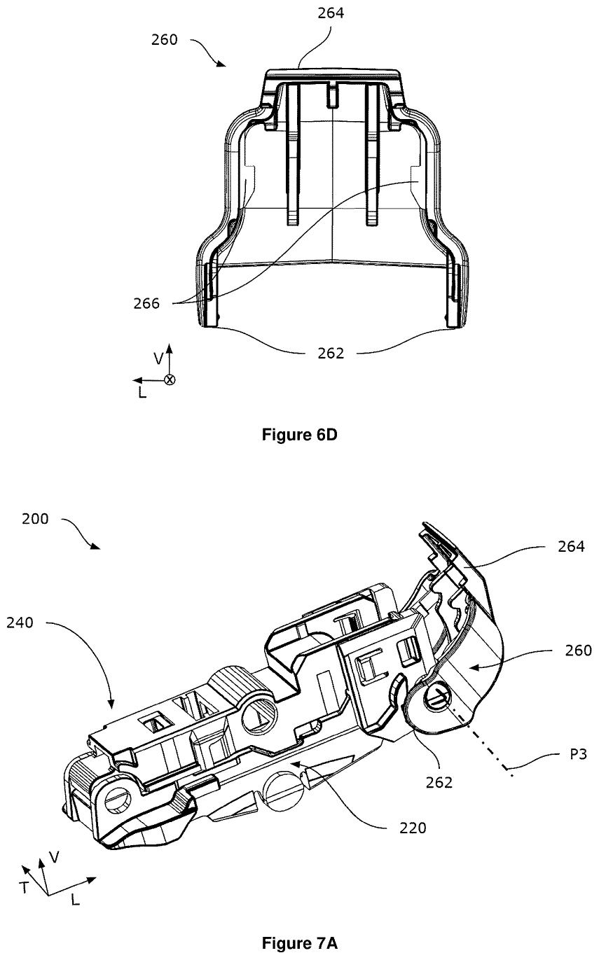

FIGS. 6A, 6B, 6C and 6D illustrate the locking cap 260. The locking cap 260 may include lower end 262 adapted to be pivotally mounted to the front end 220a of the base member 220. Further, a lip portion 264 may be formed at upper end i.e. the end opposite to the lower end 262 of the locking cap 260. The lip portion 264 of the locking cap 260 may have a step 264a that is adapted to cooperate with the wiper arm 100. The locking cap 260 may further include a fastening means 266 provided on inner surface of the cap 260, as shown in FIG. 6C. The fastening means 266 may include deformable lugs formed on inner surface of the locking cap 260. The locking cap 260 may be pivoted about the third pivot axis P3, between an unlocked state shown in FIG. 7A and a locked state shown in FIG. 7B. In locked state, the fastening means 266 of the locking tab 260 may be received in the openings 222b of the base member to secure the locking cap 260 in locked state on the base member 220. Further, the lip portion 264 of the locking cap cooperates with the wiper arm (not shown) to restrict forward and upward movements of the wiper arm 100 with respect to the adapter assembly 200, when the locking cap 260 is in locked state.

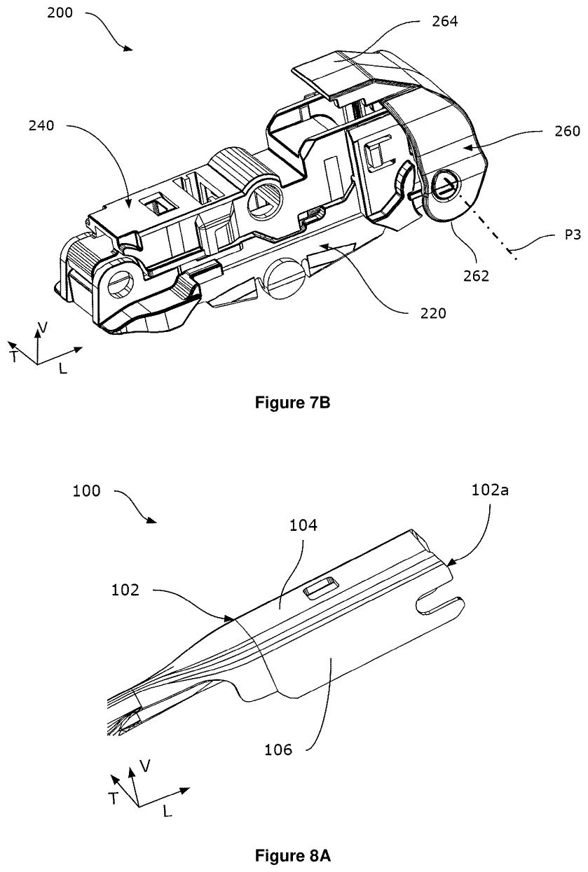

FIGS. 8A and 8B illustrate the wiper arm 100 including a yoke 102 formed at one end. The yoke 102 may generally be inverted U-shaped, with a top wall 104 connecting two side walls 106. The front end 102a of the yoke 102 may be open so that the yoke 102 may be slid onto the adapter assembly 200. The side walls 106 may include a pin 108 extending transversally towards central axis X-X of the yoke 102, from inner surface of the side wall 106, as shown in FIG. 8B.

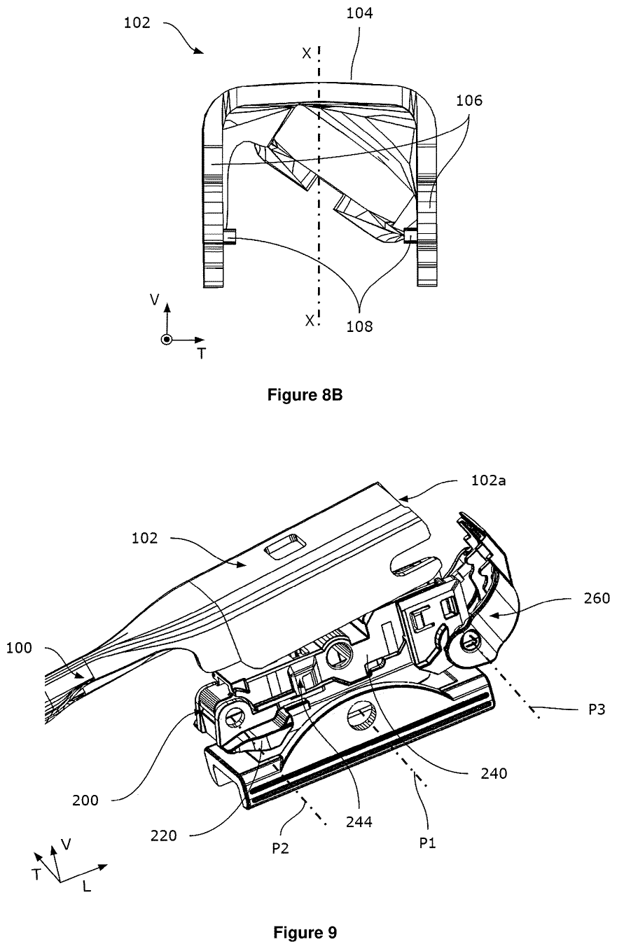

FIGS. 9, 10, 11 and 12 illustrate steps of attaching the wiper arm 100 to the adapter assembly 200. In first step, as shown in FIG. 9, the locking cap 260 is pivoted to the unlocked state, and the platform member 240 is in folded position on the base member 220. The yoke 102 of the wiper arm 100 may be positioned above the adapter assembly 200 such that the front end 102a of the yoke 102 is positioned above the front end 220a of the base member 220 as well as above the front end 240a of the platform member 240. The yoke 102 may be positioned such that the pins 108 of the yoke 102 may be positioned longitudinally forward with respect to the locking feature 244 of the platform member 240.

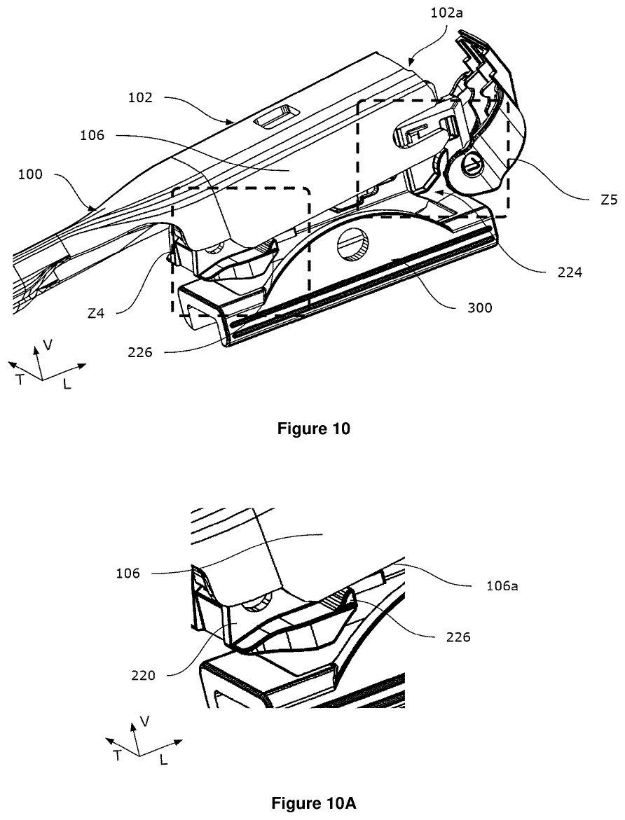

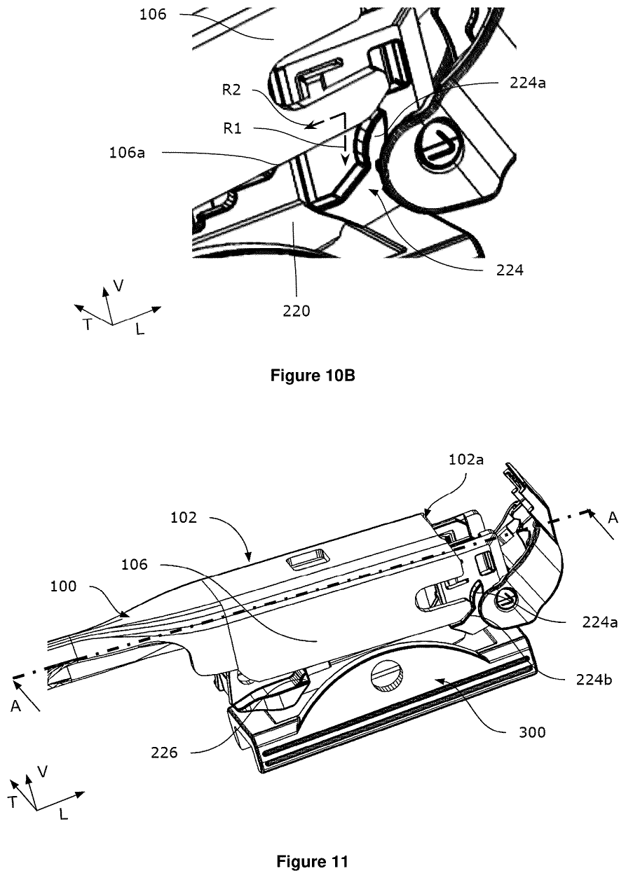

In second step, as shown in FIG. 10, the yoke 102 of the wiper arm 100 is moved vertically downwards i.e. vertically towards the adapter assembly 200, such that the side walls 106 of the yoke 102 may be positioned transversally outwards of the side walls 242 of the platform member 240. The wiper arm 100 may be moved downwards till the side walls 106 of the yoke 102 cooperates with the seating tab 226 of the base member 220. FIG. 10A shows the zoomed view of the cooperation of side walls 106 of the yoke 102 with the seating tab 226 of the base member 220. More particularly, as shown in FIG. 10A, rear portion of a lower edge 106a of the side wall 106, rests on the top surface 226a of the seating tab 226. Thus, the lower edge 106a bears against the top surface 226a of the seating tab 226, thereby supporting the yoke 102 and restricting further downward movement of the rear portion of the yoke 102 with respect to the base member 220 and the adapter assembly 200. Moreover, front portion of the side walls 106 may cooperate with the guiding tab 224 of the base member, as shown in zoomed view in FIG. 10B. The front portion of the side wall 106 cooperates with the guiding profile 224a of the guiding tab 224. The front portion of the side wall 106 may include a taper portion that comes in contact with the guiding profile 224a. When the front portion of the yoke 102 is moved further downwards as shown by arrow R1 in FIG. 10B, the guiding profile 224a pushes the yoke 102 longitudinally rearwards as shown by arrow R2 in FIG. 10B. Thus, the yoke 102 of the wiper arm 100 may be mounted on the base member 220 and the platform member 240, as shown in FIG. 11. Further, the pins 108 of the yoke 102 may be positioned in the space formed by the horizontal rib 244a and the vertical rib 244b of the locking feature 244, as shown sectional view of the assembly in FIG. 11A. Further, the front portion of the side wall 106 may now cooperate with seating profile 224b of the guiding tab 224. The seating profile 224b of the guiding tab 224, supports the side wall 106 and restricts further downwards movement of the front portion of the yoke 102 with respect to the adapter assembly 200. Moreover, the inclined portion of the seating profile may restrict forward movement of the yoke 102 with respect to the adapter assembly 200.

Further, while moving the front end 102a of the yoke 102 downwards, the flexible tab 228 of the base member 220 deforms inwards and cooperates with inner surfaces of the side walls 106 to grip the yoke 102.

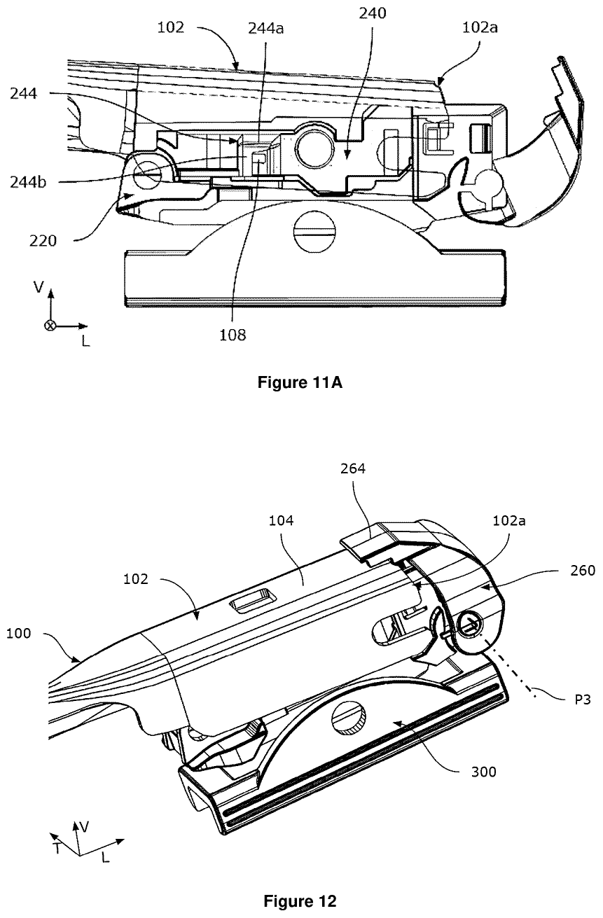

As shown in FIG. 12, the locking cap 260 may be pivoted about the third pivot axis P3 to its locked state. The locking cap 260 may be secured on the front end 220a of the base member 220 by the fastening means 266 i.e. by snap-fitting the deformable lugs into the openings 222b of the base member 220. It is to be noted that any other fastening means may be used in place of the deformable lugs and openings 222b, for securing the locking cap 260 on the base member 220. The lip portion 264 of the locking cap 260 may cooperate with the front end 102a of the yoke 102 such that at least a portion of the lip portion 264 is positioned above at least a portion of the upper wall 104 of the yoke 102, to restrict upward movement of the front end 102a of the yoke 102. Further, the frond end of the upper wall 104 of the yoke 102 may cooperate with the step 264a of the lip portion 264 to restrict the longitudinally forward movement of the yoke 102 with respect to the adapter assembly 200.

While removing the wiper arm 100 from the adapter assembly 200, first the locking cap 260 may be pivoted to its unlocked state, then the front end 102a of the yoke 102 may be moved upward and slightly forward, such that the pins 108 of the yoke 102 move out of the locking feature 244 of the platform member 240. And finally, the yoke 102 of the wiper arm 100 may be moved upwards i.e. vertically away from the adapter assembly 200.

The invention shall not, however, be limited to the means and configurations described and illustrated herein, and shall also extend to any equivalent means or configuration described and illustrated herein, and to any technical combination operating such means.

LIST OF REFERENCE SIGNS

| | |
|---|---|
| 100 | Wiper arm |
| 102 | Yoke |
| 102a | Front end of the yoke |
| 104 | Upper wall of yoke |
| 106 | Side wall of yoke |
| 106a | Lower edge of the side wall |
| 108 | Pin |
| 200 | Adapter assembly |
| 220 | Base member |
| 220a | Front end of the base member |
| 220b | Rear end of the base member |
| 222 | Longitudinal wall of base member |
| 222a | Side panel |
| 223 | Guide block |
| 222b | Opening |
| 224 | Guiding tab |
| 224a | Guiding profile |
| 224b | Seating profile |
| 226 | Seating tab |
| 226a | Top surface of the seating tab |
| 228 | Flexible tab |
| 240 | Platform member |
| 240a | Front end of the platform member |
| 240b | Rear end of the platform member |
| 240c | Upper wall of the platform member |
| 242 | Side wall of the platform member |
| 242a | Tongue |
| 244 | Locking feature |
| 244a | Horizontal rib |
| 244b | Vertical rib |
| 260 | Locking cap |
| 262 | Lower end of locking cap |
| 264 | Lip portion |
| 264a | Step |
| 266 | Fastening means |
| 300 | Connector |
| 300a | Upper side of connector |
| 300b | Lower side of connector |

1. An adapter assembly for a wiper system, the adapter assembly comprising:
a base member having a front end and a rear end;
a platform member having two side walls extending between a front end of the platform member and a rear end of the platform member, at least the rear end of the platform member being connected to the rear end of the base member; and
a locking cap having a lower end, the lower end of the locking cap being pivotally connected to the front end of the base member,
wherein the platform member includes a locking feature formed on at least one of the side walls, the locking feature being configured to restrict at least longitudinally rearward and vertically upward movement of a wiper arm with respect to the platform member.

2. The adapter assembly according to claim 1, wherein the base member includes longitudinal walls spaced apart from each other, the longitudinal walls extending between the rear end of the base member and the front end of the base member.

3. The adapter assembly according to claim 2, wherein the base member further includes a guiding tab formed on outer surface of at least one of the longitudinal walls.

4. The adapter assembly according to claim 3, wherein the guiding tab includes a guiding profile having curved shape and a seating profile having a longitudinal portion and/or an inclined portion.

5. The adapter assembly according to claim 2, wherein the base member further includes a seating tab formed on outer surface of at least one of the longitudinal walls, the seating tab having a top surface configured to cooperate with the wiper arm.

6. The adapter assembly according to claim 2, wherein the base member further includes a flexible tab provided on at least one of the longitudinal walls, near the front end of the base member.

7. The adapter assembly according to claim 1, wherein the locking feature includes a horizontal rib extending longitudinally on the side wall of the platform member, and a vertical rib extending downwards from rear end of the horizontal rib.

8. The adapter assembly according to claim 1, wherein the locking cap includes a fastening means, the fastening means being configured to cooperate with corresponding openings provided on the base member.

9. The adapter assembly according to claim 1, wherein the locking cap includes a lip portion formed at an end opposite to the lower end, the lip portion including a step configured to cooperate with the wiper arm.

10. A wiper system for a motor vehicle, the wiper system comprising:
a connector configured to be attached to a wiper blade;
a base member having a front end and a rear end, the base member being pivotally connected to the connector;
a platform member having a front end and a rear end, at least the rear end of the platform member being connected to the rear end of the base member;
a locking cap having a lower end, the lower end of the locking cap being pivotally connected to the front end of the base member; and
a wiper arm configured to be releasably secured to the platform member and to the base member,
wherein the platform member includes two side walls extending between the front end and the rear end of the platform member, and
wherein the platform member further includes a locking feature formed on at least one of the side walls, the locking feature being configured to restrict at least longitudinally rearward and vertically upward movement of the wiper arm with respect to the platform member.

11. The wiper system according to claim 10, wherein the wiper arm includes a yoke having two side walls spaced apart from each other and connected to each other by an upper wall, and a pin formed on inner surface of at least one of the side walls of the yoke.

12. The wiper system according to claim 10, wherein the base member includes longitudinal walls spaced apart from each other, the longitudinal walls extending between the rear end of the base member and the front end of the base member.

13. The adapter assembly according to claim 12, wherein the base member includes a guiding tab formed on outer surface of at least one of the longitudinal walls.

14. The adapter assembly according to claim 13, wherein the guiding tab includes a guiding profile having curved shape, and a seating profile having a longitudinal portion and/or an inclined portion.

15. The adapter assembly according to claim 12, wherein the base member further includes a seating tab formed on outer surface of at least one of the longitudinal walls, the seating tab having a top surface configured to cooperate with the wiper arm.

16. The adapter assembly according to claim 12, wherein the base member further includes a flexible tab provided on at least one of the longitudinal walls, near the front end of the base member.

17. The adapter assembly according to claim 10, wherein the locking feature includes a horizontal rib extending longitudinally on the side wall, and a vertical rib extending downwards from rear end of the horizontal rib.

18. The adapter assembly according to claim 10, wherein the locking cap includes a fastening means, the fastening means being configured to cooperate with corresponding openings provided on the base member.

19. The adapter assembly according to claim 10, wherein the locking cap includes a lip portion formed at an end opposite to the lower end, the lip portion including a step configured to cooperate with the wiper arm.
